(19) United States
(12) Patent Application Publication
(10) Pub. No.: US 2024/0273847 A1
(43) Pub. Date: Aug. 15, 2024

(54) VIRTUALIZED SPORTING EVENTS

(71) Applicant: Gilad Eliezer Tsur Mayer, Kefar Sava (IL)

(72) Inventor: Gilad Eliezer Tsur Mayer, Kefar Sava (IL)

(21) Appl. No.: 18/443,229

(22) Filed: Feb. 15, 2024

Related U.S. Application Data
(60) Provisional application No. 63/445,807, filed on Feb. 15, 2023.

(51) Int. Cl. G06T 19/20; A63F 13/52; A63F 13/56

(52) U.S. Cl. CPC G06T 19/20; A63F 13/52; A63F 13/56; G06T 2219/2012

(57) ABSTRACT

Aspects of the present disclosure generally relate to systems and processes for generating a virtual gaming environment for digital sporting competitions. The system can include a data store and at least one computing device in communication with the data store. The computing device can receive one or more character graphic sets individually corresponding to one or more remote computing devices. The character graphic sets can correspond to at least one physical property of a respective user of one of the remote computing devices. The computing device can generate a digital representation of a sports game including one or more players, wherein the players can be associated with teams. The computing device can cause the digital sports game to be rendered on the remote computing devices using the character graphics sets corresponding to one or more of the players.

### CROSS-REFERENCE TO RELATED APPLICATIONS

This patent application claims the benefit of, and priority to, U.S. Provisional Patent Application No. 63/445,807, filed Feb. 15, 2023 and entitled “A METHOD OF ORGANIZING VIDEO GAME SOCCER TOURNAMENTS,” the contents of which are incorporated by reference in its entirety as if set forth herein.

### TECHNICAL FIELD

The present systems and processes relate generally to digital representations of sporting events.

### BACKGROUND

The present systems and processes relate generally to the field of video game sporting events. The present systems and processes also relate generally to the field of generating avatars from image data.

There is some existing technology related to video game soccer competitions and generating avatars from image data. For example, U.S. Pat. No. 11,369,880 (2022) by Aghdaie, et al. discloses embodiments performing granular difficult adjustments. In some of those embodiments, the difficulty adjustment is undetectable by a user. In other embodiments, the invention is able to review historical user activity data with regard to one or more video games to generate a game retention prediction model that is able to predict an indication of an expected gameplay duration. The technology aims to ensure that the video games implementing the invention maintain a difficulty level that is likely to keep the players engaged for a long period of time. U.S. Pat. No. 11,369,880 can be implemented in various video games, including, but not limited to, video game soccer competitions. U.S. Pat. No. 9,697,635 (2017) by Quinn et al. reveals a technology for automatically generating a facial avatar resembling a user in a defined art style. The invention allows one or more processors to generate a user 3D head model of a user on the basis of captured 3D image data from a 3D image capture device.

The existing prior art, including the aforementioned patents, does not disclose any invention that allows its users to: (i) create personal in-game avatars by scanning their faces; (ii) enable the avatars to appear in a virtual world related to video game sporting tournaments; and (iii) receive compensation for their participation in video game sporting events. In light of what is discussed above, there is a long-felt but unresolved need in the art for a method for organizing video game sporting tournaments.

### BRIEF SUMMARY OF THE DISCLOSURE

Aspects of the present disclosure generally relate to a virtual gaming environment for digital sporting competitions. According to various embodiments of the present disclosure, users can join teams in a team sport and individually control player avatars such that there is a one-to-one mapping between users and virtually generated players. In other words, if a team were playing soccer, it can include 11 users corresponding to the 11 players on the soccer team, with each user controlling one player. Teams can be a part of competitions and play a fixed schedule of games. Players and teams can interact in an entirely virtual environment to generate a novel virtual sporting world.

These and other aspects, features, and benefits of the claimed innovation(s) will become apparent from the following detailed written description of the preferred examples and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more examples and/or aspects of the disclosure and, together with the written description, serve to explain the principles of the disclosure. Wherever possible, the same reference numbers are used throughout the drawings to refer to the same or like elements of the disclosed technology, and wherein:

FIG. 1 illustrates an example gaming environment, according to various embodiments of the present disclosure.

FIG. 2 illustrates an example networked environment, according to various embodiments of the present disclosure.

FIG. 3 illustrates an example user interface corresponding to a portion of the functionality implemented by portions of the gaming environment, according to various embodiments of the present disclosure.

FIG. 4 illustrates an example user interface corresponding to a portion of the functionality implemented by portions of the gaming environment, according to various embodiments of the present disclosure.

FIG. 5 illustrates an example flowchart of certain functionality implemented by portions of the gaming environment, according to various embodiments of the present disclosure.

### DETAILED DESCRIPTION

For the purpose of promoting an understanding of the principles of the present disclosure, reference will now be made to the examples illustrated in the drawings and specific language will be used to describe the same. It will, nevertheless, be understood that no limitation of the scope of the disclosure is thereby intended; any alterations and further modifications of the described or illustrated examples and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to a virtual gaming environment for digital sporting competitions. According to various embodiments of the present disclosure, users can join teams in a team sport and individually control player avatars such that there is a one-to-one mapping between users and virtually generated players. In other words, if a team were playing soccer, it can include 11 users corresponding to the 11 players on the soccer team, with each user controlling one player. Teams can be a part of leagues, tournaments, and other competitions, and play a fixed schedule of games. Players and teams can interact in an entirely virtual environment to generate a novel virtual sporting world.

### Example Embodiments

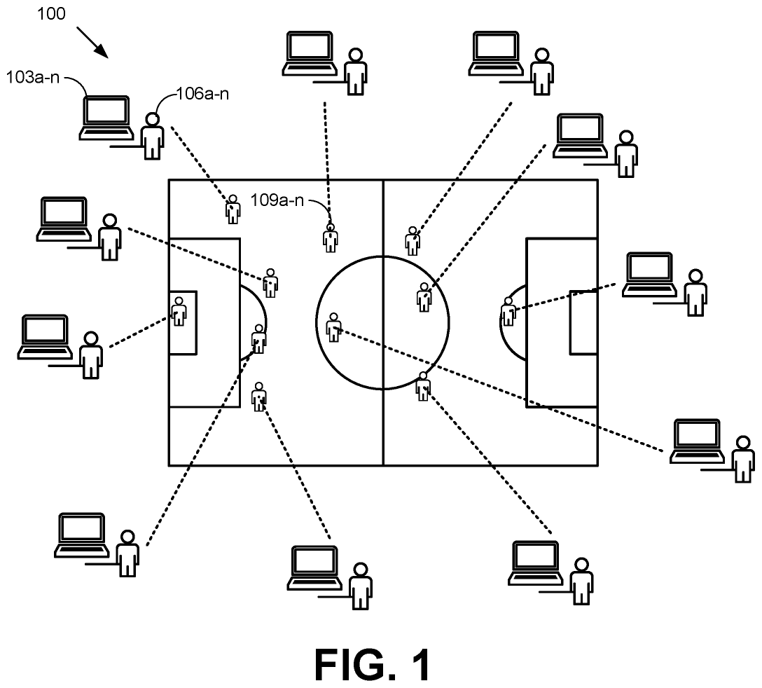

Referring now to the figures, for the purposes of example and explanation of the fundamental processes and components of the disclosed systems and processes, reference is made to FIG. 1, which illustrates an example, high-level overview of a gaming environment 100. As will be understood and appreciated, the example, high-level overview of the gaming environment 100 shown in FIG. 1 represents merely one approach or example of the present system, and other aspects are used according to various examples of the present system.

The gaming environment 100 can include a virtual environment for playing one or more games. For example, the gaming environment 100 can include a rendered virtual soccer field with one or more avatars 109. The avatars 109 can interact in the gaming environment 100 to perform one or more objectives associated with the particular game. Though discussed in the context of a virtual soccer field and the sport of soccer, the gaming environment 100 can include any particular sporting game. For example, the gaming environment 100 can include a virtual baseball field, a virtual American football field, and/or a virtual basketball court for playing each of the associated sports.

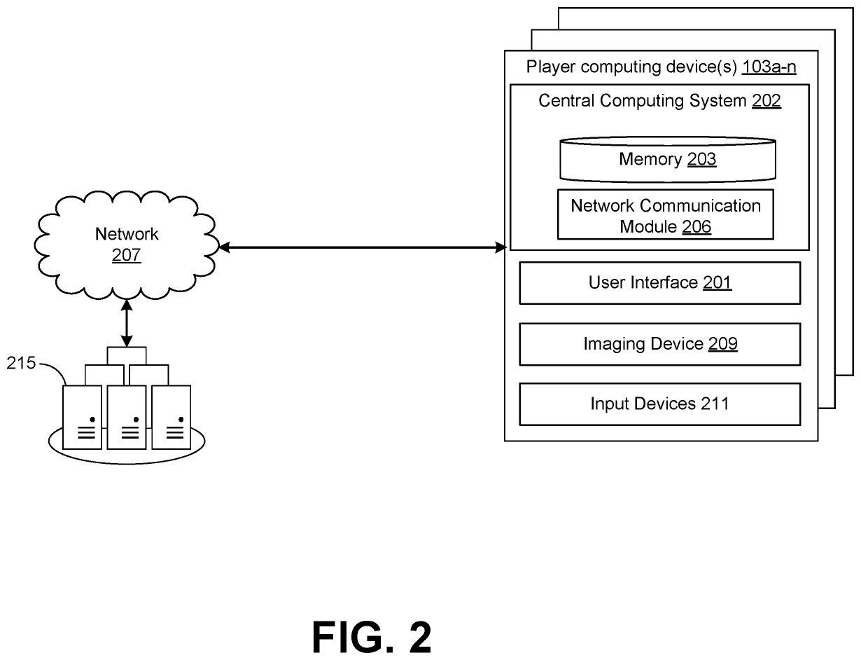

The gaming environment 100 can include one or more player computing devices 103. The player computing devices 103 can include mobile devices, personal computers, gaming systems, virtual reality systems, and/or any other suitable computing device. The player computing devices 103 can function as control systems for managing the avatars 109. For example, the gaming environment 100 can render the virtual soccer field and the avatars 109. The player computing devices 103 can generate various commands to control the avatars 109 and perform the objectives of the game. The player computing devices 103 can include one or more input devices 211 (see FIG. 2 for further details) to receive commands from one or more players 106. The players 106 can operate the player computing devices 103 through the input devices 211. The player computing devices 103 can receive inputs through the input devices 211 and use the inputs to control the avatars 109. For example, the player 106 can interact with a video game controller functioning as the input device 211 of the player computing device 103. Continuing this example, the video game controller can send commands to the player computing device 103 to control the avatar 109 in the gaming environment 100.

The gaming environment 100 can include one or more avatars 109. The avatars 109 can be three-dimensional renderings of human players. For example, the gaming environment 100 can generate the avatars 109 based on a three-dimensional (also referred to herein as 3D) scan of the players 106, an image of each of the players 106, and/or any other input data associated with each player 106. The avatars 109 can engage in a digital representation of a team or individual sport. For example, the gaming environment 100 can include 22 avatars 109, where each avatar 109 is controlled by a particular player 106 through the player computing device 103. Continuing this example, the gaming environment 100 can render a soccer game, where 22 avatars 109 are split into two teams of 11 avatars 109.

Each player 106 can control one avatar 109 such that there is a one-to-one mapping between players 106 and their digitally represented avatars 109. Some avatars 109 can be controlled automatically by a computing device without user input through the input devices 211. For example, if players 106 are engaging in a digital representation of a soccer game, one player 106a can control an avatar 109a corresponding to the goalkeeper of a team, and another player 106b can control an avatar 109b corresponding to the striker of a team, and a computing device can control an avatar 109c corresponding to a midfielder of a team.

The gaming environment 100 can render the digital sporting event for each player 106 in a first-person view format, such that each player experiences the sporting event from a unique perspective. For example, the gaming environment 100 can render the digital sporting event from the first-person perspective of the goalkeeper on the player computing device 103a associated with the goalkeeper. Alternatively, the gaming environment 100 can render the digital sporting event from a third-person point of view, such that players 106 can see the entire field and all players 106 at the same time. The gaming environment 100 can receive a selection from each of the players 106 as to which view they prefer. The gaming environment 100 can render the sports game on each player 106's computing device from the selected point of view, for example, the game can be rendered from a first-person point of view for one player 106 and another player 106 experiences it from a third-person point of view. Team sports can include soccer, football, baseball, basketball, hockey, or other suitable team sports.

The gaming environment 100 can include a payment system for the players 106. The players 106 can enter into contracts with teams. The contracts can determine the payment structure for the players 106. The players 106 can be paid a fixed fee for each game played, or can be paid a specified percentage of prize money associated with a competition. Contracts for the players 106 can further include bonus clauses based on team performance. For example, various players 106 on the same team may receive a bonus if their team wins a league championship.

Referring now to FIG. 2, illustrated is a networked environment 200, according to one embodiment of the present disclosure. The networked environment 200 can function as the computing infrastructure that manages the gaming environment 100. The networked environment 200 can include player computing devices 103. The player computing devices 103 can function as an interactive source for rendering games, receiving inputs from the players 106, and/or managing any data associated with the players 106 and the gaming environment 100. The player computing devices 103 can include but are not limited to gaming consoles, cellular devices, tablets, computers, personal laptops, virtual reality systems, and/or any other particular computing device.

The player computing devices 103 can each include a central computing system 202. The central computing system 202 can function as the central computing environment of the player computing devices 103. For example, the central computing system 202 can process data received from one or more input devices 211, render one or more gaming environments 100, update the gaming environment 100 in real-time, determine outcomes of the particular game in real-time based on the inputs received from the input devices 211, and/or perform any other computational requirements of the player computing devices 103.

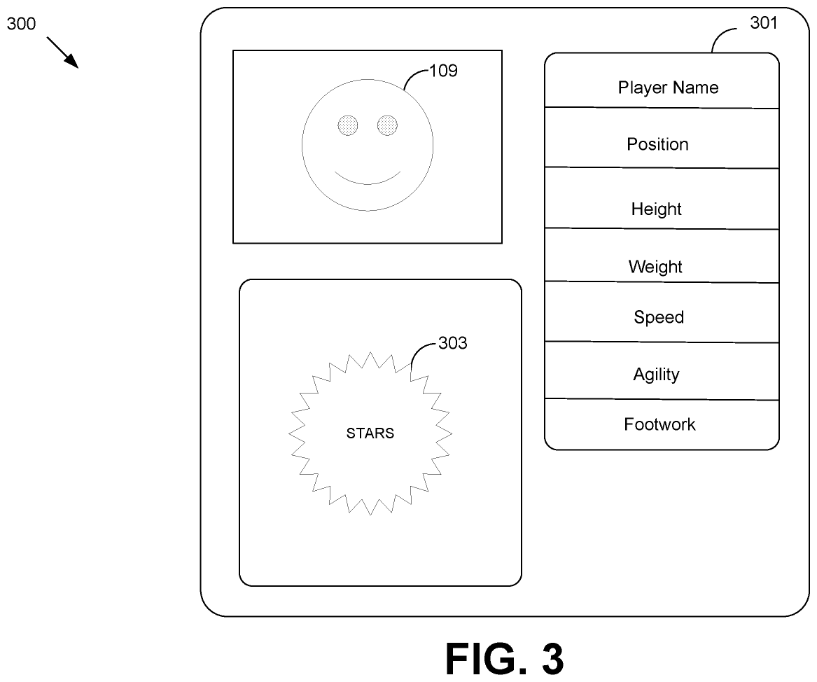

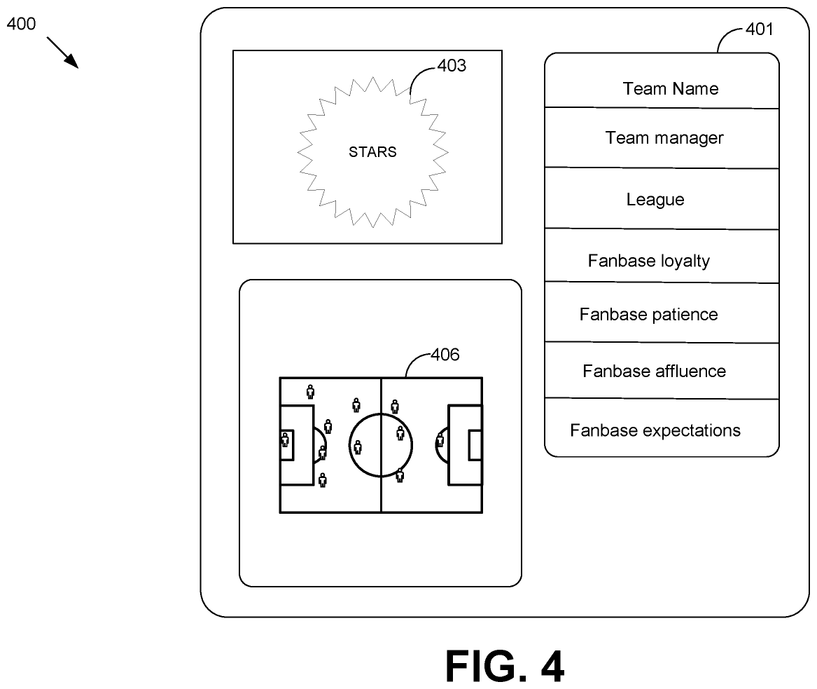

The player computing devices 103 can each include a memory 203. The memory 203 can function as a high-speed storage device, a short-term storage device (e.g., Random Access Memory (RAM)), a long-term storage device, and/or any particular combination thereof. The memory 203, for example, can store player data, rendering data, sports data, team data, and/or any other data associated with the gaming environment 100. The player data can include any data associated with the players 106. For example, the player data can include but is not limited to player profiles 300 (see FIG. 3 for further details), account names, account passwords, financial information, 3-D rendering data, image data, player names, and associated teams. The rendering data can include any data associated with rendering the gaming environment 100. For example, the rendering data can include a seat map, a stadium rendering, a field rendering, rendered sports equipment, and one or more avatar renderings. The sports data can include any data associated with the particular sport being played in the gaming environment 100. For example, the sports data can include but is not limited to sports rules and calculations for defining physics constraints for the particular sport. The team data can include any data associated with one or more teams. For example, the team data can include team profiles 400 (see FIG. 4 for further details), associated competitions, associated players 106, team ranks, team leagues, and/or any other information associated with the teams. Though discussed in the context of the memory 203, the data stored in the memory 203 can be stored in a memory 203, in a gaming server 215, and/or in any particular combination of data locations distributed across the network 207.

The player computing devices 103 can each include a network communication module 206. The network communication module 206 can function as a data distribution source for the one or more player computing devices 103. For example, the network communication module 206 can send data to any location distributed across the network 207. In another example, the network communication module 206 can receive data from any particular location distributed across the network 207.

The player computing devices 103 can each include a user interface 201. The user interface 201 can include a rendered interface that can display the gaming environment 100, interactive pages, account setting pages, account login pages, and/or any particular interface for the player computing devices 103. The user interface 201 can update in real-time to display the live action of a particular game. The user interface 201 can vary based on inputs received through the input devices 211. For example, the movements of a particular avatar 109 can change in real-time on the user interface 201 based on inputs received from the input devices 211.

The player computing devices 103 can each include an imaging device 209. The imaging device 209 can be a mobile phone camera, a standalone camera, a webcam, or a specialized three-dimensional (3D) scanner. The imaging device 209 can be used to generate a 3D representation of a user's face. The 3D representation of the user's face can be used to generate custom avatars 109 for the players 106.

The player computing devices 103 can each include one or more input devices 211. The input devices 211 can generate inputs from the players 106. For example, the input devices 211 can include gaming controllers, keyboards, mouses, touch screen displays, virtual reality controllers, microphones, cameras, touchpads, and/or any other particular input device. The input devices 211 can generate inputs that control their respective avatars 109.

The imaging devices 209 can obtain a 3D representation of the face of a player 106 by capturing one or multiple images of the face of the player 106 from multiple angles. The player computing device 103 can stitch the multiple captured images together to generate a 3-dimensional map of the user's face. The stitching process can include identifying facial landmarks of interest in each image, and co-registering the images together based on the relative positions of the landmarks in each image. For example, image processing software resident on the player computing device 103 or the gaming server 215 can identify the location of a user's nose, eyes, eyebrows, and mouth in each image. Image processing software can compute a distance between the identified facial landmarks in each image, and combine the measured distances from images captured at different angles to determine a three-dimensional shape of the user's face. The three-dimensional shape can then be used to generate an avatar 109.

In one embodiment, the gaming server 215 generates 3D representations of the faces of players 106 based on pre-captured images supplied by the player 106. For example, the gaming server 215 can access one or more locally stored images of the player 106's face on the player computing device 103. Image processing software resident on the gaming server 215 can analyze the retrieved images to identify the locations of facial landmarks and generate a 3D representation of the player 106's face according to the methods described above. In another example, the gaming server 215 or the player computing device 103 can connect with one or more social media accounts of a particular player 106. Continuing this example, the gaming server 215 and/or the player computing device 103 can extract from the social media accounts of the particular player 106 one or more facial images. Further continuing this example, the gaming server 215 and/or the player computing device 103 can generate a 3D representation of the face of the particular player 106.

The gaming server 215 can alter an image provided by a player 106 according to the preferences of the player 106. For example, a player 106 can provide an image and select changes to the hair color, facial shape, or other visual feature. The gaming server 215 can apply image processing algorithms to adjust the desired feature prior to generating a 3D representation of the player 106's face.

The gaming environment can include a gaming server 215. The gaming server 215 can generate digital representations of sporting events and communicate them to player computing devices 103 via the network 207. The gaming server 215 can receive player information from the player computing devices 103. For example, the gaming server 215 can receive information as to the three-dimensional shape of a user's face. The gaming server 215 can combine received information from multiple players to generate a virtual rendering of a sporting event. For example, in a soccer context, the gaming server 215 can receive player information from 22 different players corresponding to 22 different positions on the field. The gaming server 215 can combine the received information to generate individual representations of each player 106 on the virtual field. The gaming server 215 can transmit the generated representations to the player computing devices 103 such that each player 106 can experience the digital sporting event. The gaming server 215 can receive inputs from the players 106 to move avatars 109 on the field during the virtual sporting event. The gaming server 215 can combine inputs from all players 106 and update the positions of the avatars 109 on the virtual field according to the received inputs.

The player computing devices 103 can be communicatively coupled to each other and to the gaming server 215 via a network 207. The network 207 can be a local area network, or the internet. According to various embodiments of the present disclosure, the gaming environment 100 can split the workload associated with generating and maintaining the virtual gaming environment 100 between the player computing devices 103 and the gaming server 215. For example, the gaming server 215 can execute processes associated with generating a digital sporting event, keeping track of relevant player data, and integrating user inputs across multiple devices (so-called “back-end” processes). The player computing devices 103 can execute processes associated with rendering graphical displays to the players 106.

Referring now to FIG. 3, shown is an exemplary player profile 300, according to various embodiments of the present disclosure. The player profile 300 can include attributes 301. The attributes 301 can include physical or descriptive attributes. Physical or descriptive attributes can include a player name, a player position, a player height, a player weight, and other suitable descriptive attributes. The attributes 301 can further include athletic attributes. Athletic attributes can be a set of athletic skills scored according to a rating system. For example, the gaming server 215 can implement a rating system wherein each athletic attribute receives a score between 1 and 20. Athletic attributes can include speed, agility, footwork, and other suitable athletic attributes related to the sport of interest. The gaming server 215 can determine athletic attributes based on physical features of the player 106. Physical features of the player 106 can include player height, player weight, player arm length, and other physical measurements. The gaming server 215 can receive physical measurements from the player 106 via the player computing device 103 or can infer the physical features of the player 106 based on images provided by the player 106. The gaming server 215 can receive additional physical attributes from the player computing device 103 as self-reported by the player 106 including speed, strength, and agility. In some embodiments, the gaming server 215 can determine physical attributes of the player based on video footage of a player 106 engaging in an athletic activity received from the player computing device 103. In some embodiments, the gaming server 215 can determine the value of various physical attributes based on the player 106 completing a series of physical tests and inputting the results into the player computing device 103.

In some embodiments, a player 106 can improve the attributes associated with their player profile 300 through training. In one embodiment, the gaming server 215 can receive a selection of attributes 301 from a player 106 on a weekly basis. Each week, the player 106 can select a different attribute or attributes 301 to improve. Training can include various in-game activities designed to strengthen a particular skill set in a player 106. For example, a player 106 can improve a goal-scoring attribute by participating in a mini-game wherein the player 106 repeatedly shoots a ball at a series of targets. The gaming server 215 can determine the degree to which the attribute increases based on the player 106's level of performance in the training activity. For example, if the player 106 engages in a goal-scoring training exercise and achieves a perfect score, the gaming server 215 can increase the player 106's goal-scoring attribute by a specific amount (i.e., 3 points). If the player 106 engages in the same training exercise and fails to score at all, the gaming server 215 can leave the player 106's goal-scoring attribute unchanged. In some embodiments, the gaming server 215 can assign random attribute values that cannot be improved to avatars 109 that are not controlled by players 106.

Attributes 301 can include personality attributes associated with a player 106. Personality attributes can include joyfulness, seriousness, calmness, passion, sportsmanship, cockiness, or other suitable personality attributes. The gaming server 215 can display personality attributes on the profile 300. The gaming server 215 can receive selections of personality attributes from the player 106 via the player computing device 103 or can automatically assign personality attributes based on the actions of the player 106 within the digital game. For example, in a soccer setting, the gaming server 215 can adjust a sportsmanship attribute every 2 weeks based on the number of yellow or red cards accumulated by the player 106.

The players 106 can improve the attributes 301 associated with their player profile 300 by purchasing upgrades. Upgrades for purchase can include changes to an avatar 109, changes to the player 106's name, or changes to athletic attributes 301. The players 106 can further make changes to the team associated with their player profile 300. For example, the players 106 can enter into contracts with one or more teams for a fixed period of time and at a fixed rate of pay.

The player profile 300 can include a depiction of the player 106's avatar 109. The gaming server 215 can receive a set of customized settings for player 106's avatar 109 from the player computing device 106. The avatar 109 can include multiple customizable features. Customizable features of the avatar 109 can include the height, weight, hair color, eye color, facial features, and other physical features of the avatar 109. Customizable features can also include customizable equipment. For example, a soccer player 106's avatar 109 can include selectable soccer cleats, shin guards, and other relevant pieces of athletic equipment related to the player 106's sport and position. The gaming server 215 can automatically generate the avatar 109 based on a 3D scan of the player 106's face according to embodiments described above in reference to FIG. 2.

The player profile 300 can include a team 303. The gaming server 215 facilitate a process by which a player 106 can enter into a contract with one or more teams 303. For example, a player 106 can enter into an agreement with a team 303 such that the player 106 receives remuneration in the form of fiat currency, cryptocurrency, or other suitable form of payment. Payment structures can be fixed fee on a per-game basis, or per-season. The players 106 can negotiate contracts with managers of the teams 303 for which they play. Player contracts can include bonus clauses. For example, a player 106 may receive an end-of-season bonus if they score a certain number of goals, if the team 303 wins a certain number of games, or if the team 303 achieves a certain set of objectives. Objectives can include, for example, winning or finishing in the top 3 teams 303 in the final season standings. The gaming server 215 can facilitate a mechanism for players 106 to transfer between teams 303, such that a player 106 can move from one team 303 to another while maintaining the terms of his or her contract. For example, a player 106 with a contract to play two seasons at a first team 303 can be transferred halfway through the first season to a second team 303. The contract then belongs to the second team 303, and the player 106 remains under contract to finish out the two seasons for which he or she is contracted. Player transfers can be accomplished wherein one team 303 pays a transfer fee to another team 303 to purchase the rights to the player 106's contract. The player profile can include a depiction of the team logo, a team jersey, or other suitable representation of the player 106's team 303.

Referring now to FIG. 4, shown is an exemplary team profile according to various embodiments of the present disclosure.

Each team can have an associated team profile 400. The team profile 400 can include team attributes 401. Team attributes 401 can include a team name, a team manager, a team league, a team location, and other descriptive attributes. The team profile 400 can include a team logo 403. The gaming server 215 can automatically generate the team logo 403 or can receive a logo customized according to preferences of players 106 from the player computing device 103. Each team can have an owner. The owner can be a human or artificial intelligence (AI) representative. The gaming server 215 can determine team logos, colors, jersey designs, and other features based on selections from the team owner. The game server 215 can render the graphical depiction of the players from the team to be rendered based on the selections of the team owner. For example, a player on the team can be rendered with a jersey in the color selected, of the design selected, and with the logo selected. The team profile 400 can include a team roster 406. The team roster 406 can be a listing of players 106, or a graphical depiction of players 106 and their positions on the playing surface. The team roster 406 can include a depiction of commonly used formations by the team.

The gaming server 215 can store team data in groups of teams corresponding to leagues, tournaments, or other competitions. Teams within the same league can play a fixed schedule of games. In an example embodiment in the context of soccer, each country can have a national soccer association and each continent can have a national continental association and each national soccer association can be governed by the respective continental soccer association. The members of each association can participate in the resolution of disputes related to the teams of the respective country. Each soccer season can include a predetermined number of match weeks (e.g., 14 weeks) and each season can be numbered consecutively. The gaming server 215 can randomly generate the weather conditions during soccer matches in the virtual world, or the gaming server 215 can generate weather conditions similar to the weather in the non-virtual country associated with the country in which the matches will be played. For example, if a match is played in the virtual country Germany, the gaming server 215 can generate weather during the digital sporting event that resembles German weather. Each league can have the structure of a pyramid and, more particularly, the term “league” can refer to a layer in the pyramid layer and the term “division” can refer to a cell in the pyramid layer. In one embodiment, a win in a match can grant 3 points to the winning soccer team, a draw can grant 1 point, and a loss can grant 0 points. In various embodiments, an association can have a first league which can have one division, a second league which can have two divisions, and a third league which can have four divisions. The first league can have a name described in words (e.g., “Premier League”), and the divisions in the second, third, and other leagues can be named with a single English letter (e.g., A, B, C, D.).

In one embodiment, players 106 associated with each country can vote for an international manager of the country after the expiration of a predetermined length of time. For example, an international manager can be selected every two seasons. Each country can have a national competition and club competitions. After the end of each league season, the participants in the league can be promoted to a higher league or can be demoted to a lower league.

The teams can have reputations. In an exemplary embodiment, a team reputation is a number which indicates the strength of a team relative to other teams. The gaming server 215 can determine a team reputation based on team performance. The gaming server 215 can use the team reputation to determine the degree to which a player 106's attributes increase through training. For example, a player 106 associated with a team with a higher reputation can improve particular skills more than a player 106 associated with a team with a lower reputation score. The gaming server 215 can determine team reputations based on a combination of the reputations of the players 106 on the team. Team reputations can change over time as the team's roster changes. In an additional embodiment, team reputations can include personality reputations. For example, a team can develop a reputation as a sportsmanlike team if the players 106 on the team engage in a sportsmanlike manner within the gaming environment. The gaming server 215 can automatically determine the reputation of a team based on the activity of the team's players 106 within the gaming environment 100. The gaming server 215 can include a machine learning model, artificial intelligence platform, neural network, algorithm, or other suitable model for determining team reputations. According to various embodiments, the gaming server 215 can include one or more machine learning models which process game statistics. The gaming server 215 can combine the outputs of the machine learning models to classify a team's reputation across multiple variables. For example, the gaming server 215 can combine the model outputs to classify a team's reputation with respect to sportsmanship, patience, athleticism, or other variables. The team's reputation can include factors related to the overall makeup of the team.

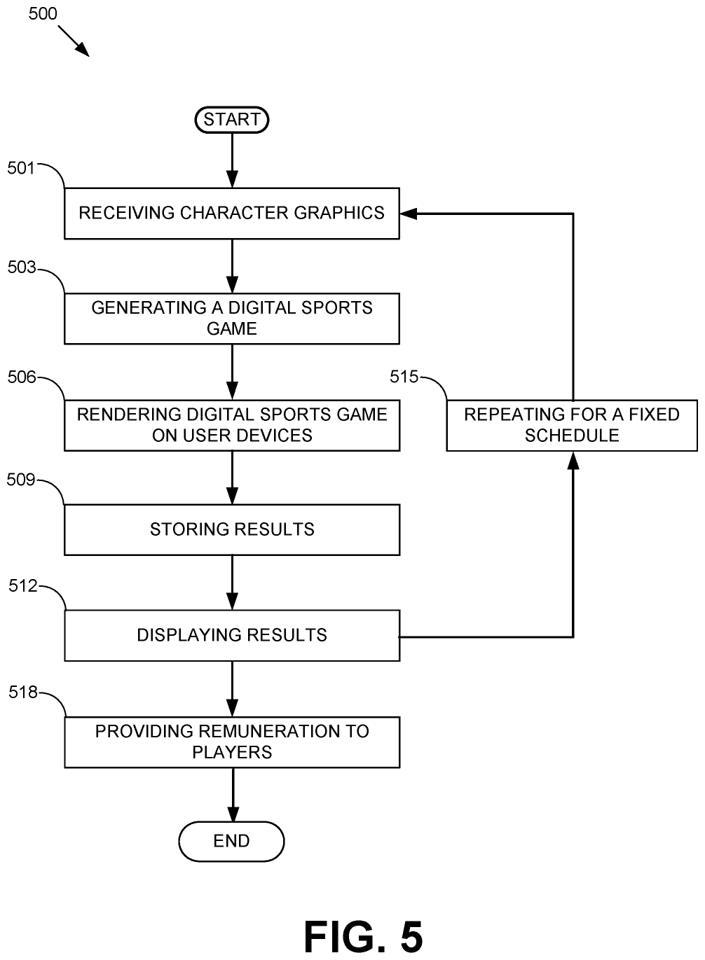

As will be understood by one having ordinary skill in the art, the steps and processes shown in FIG. 5 (and those of all other flowcharts and sequence diagrams shown and described herein) may operate concurrently and continuously, are generally asynchronous and independent, and are not necessarily performed in the order shown.

Referring now to FIG. 5, shown is an exemplary process 500 for operating the gaming environment according to various embodiments of the present disclosure.

At step 501, process 500 can include receiving character graphics. The gaming server 215 and/or the player computing devices 103 can receive the character graphics. For example, the player computing device 103 can receive character graphics through the imaging device 209. Continuing this example, the gaming server 215 can receive character graphics from the player computing devices 103. The gaming server 215 can receive images of players captured by the player computing devices 103. The gaming server 215 can use the received images to generate avatars 109. Character graphics can be customized avatars 109 with design selections made by the user. Character graphics can be avatars 109 generated based on a 3D scan of a user's face. The gaming environment 100 can store character graphics locally on the player computing devices 103 or in a database associated with the gaming server 215. Receiving character graphics can include prompting a player 106 to select character graphics. For example, the gaming server 215 can present the player 106 with a selection screen allowing the player to choose between a custom avatar, or an avatar generated based on a 3D scan of the player 106's face.

At step 503, process 500 can include generating a digital sports game. For example, the gaming server 215 can generate a digital sports game, which can include the received character graphics. Generating a digital sports game can include generating a rendering of a venue for the sporting event. For example, the digital sports game can include a soccer stadium with stands for fans, a field, and soccer goals. The gaming server 215 can receive user generated digital sporting event venues or can automatically generate digital sporting event venues based on real-world sporting event venues. For example, the gaming server 215 can automatically render a known soccer stadium based on provided images or a predetermined 3D model of that soccer stadium. For a particular game, the gaming server 215 can render a digital sporting event venue according to a selection of a venue from one or more players 106, or according to a predetermined schedule of venues for games. Generating a digital sports game can further include rendering the avatars 109 on the field. For example, the gaming server 215 can render player avatars 109 on the virtual field at locations determined by the positions of the players. Generating a digital sports game can include adjusting the locations of the avatars 109 on the virtual field based on input received from the players 106. For example, a player 106 can control the movement of their respective avatar using an input device 211 associated with the player computing device 103.

At step 506, process 500 can include rendering the digital sports game on the player computing devices 103. For example, the gaming server 215 can transmit the generated digital sports game to the player computing devices 103 via the network 207. The gaming server 215 can, in real time, coordinate the rendered digital sports game such that it is synchronized across all player computing devices 103. For example, the gaming server 215 can generate a rendering of a series of frames corresponding to a particular amount of time within the game, and transmit the frames to the player computing devices 103 via the network 207 at regular intervals. In one embodiment, the gaming server 215 can receive inputs from the player computing devices 103 and stores them in a buffer. The gaming server 215 can then generate video frames depicting the appropriate movement of player avatars 109 corresponding to the player inputs in the buffer. The gaming server 215 can transmit the generated video frames to the player computing devices 103 via the network 207 while simultaneously filling the buffer with the next set of inputs from the player computing devices 103. The amount of time associated with buffer storage directly correlates to the performance of the gaming environment. Smaller buffers result in higher refresh rates, thereby creating a more real-time experience for players 106.

At step 509, process 500 can include storing the results of the digital sports game. For example, the gaming server 215 can store the results of the digital sports game in a data store. Storing the results of the digital sports game can include storing the score of the game, the rosters of each team that competed in the game, individual player statistics, and other relevant data. Storing the results of the digital sports game can include storing the results in a database that is accessible to users of the gaming environment via an application. For example, players 106 interested in a specific team or specific player 106 can access single game and season statistics for a team or player 106 of interest by accessing the database. The gaming server 215 can use statistics in the database to generate predictions of outcomes for future games. For example, the gaming server 215 can compile average offensive and defensive statistics for teams in an upcoming game and apply a trained machine learning model to generate a predicted score or outcome of the game. The gaming server 215 can display the predicted score or outcome can be displayed to the players 106 prior to the game to increase engagement. The data store can be local to the gaming server 215 or can be at a remote location.

At step 512, process 500 can include displaying the results of the digital sports game to the players 106. For example, gaming server 215 can generate an outcome display which includes various statistics associated with the outcome of the digital sports game. Statistics can include team statistics and individual statistics. Team statistics can include goals scored, goals allowed, penalties, fouls, or other rule infractions accumulated, turnovers, and other statistics associated with the sport of interest. Individual statistics can include individual performance metrics associated with a player 106's particular role in the game. Gaming server 215 can transmit the outcome to player computing devices 103 and render it on their respective displays. The players 106 can adjust the desired view of the outcome according to their preferences. For example, players 106 interested in specifically defensive statistics can choose to only look at defensive statistics for their teams or players 106 of interest.

Displaying the results of the digital sports game can include applying analytics to data collected during the game to forecast future performance of players 106. For example, data collected from the input device 211 of the player computing device 103 can be used to determine the skill level of an individual player 106 relative to other players 106. The gaming server 215 can use data collected over time to forecast a player 106's performance at a later date. For example, the gaming server 215 can estimate the reaction time of a player 106 based on the amount of time between an event of interest and the player 106's adjustment of the input device 211 in response to that event. The gaming server 215 can aggregate the average reaction time of a player 106 across games within a season. The gaming server 215 can apply a linear regression model to the aggregated reaction time metrics to generate a predictive linear model of the player 106's reaction time at a future time.

The gaming server 215 can use forecasted performance estimates to determine a future value of a player 106 for the purposes of contract negotiation and transfer considerations. For example, the gaming server 215 can compare a predicted statistic of interest for a particular player 106 to that statistic across the pool of all players 106 to determine a future contract value for that player based on the predicted statistic. The gaming server 215 can generate a range of predicted contract values based on a generated confidence interval for a predicted statistic for a particular player.

At step 515, process 500 can include repeating steps 501-512 according to a fixed schedule of games for particular groups of teams and players 106. For example, the gaming server 215 can execute steps 501-512 on a weekly basis, with teams within a league competing in a round-robin style tournament such that each team plays at least one game against each other team.

At step 518, process 500 can include providing a remuneration to the players 106. For example, upon completion of a game or a competition, the gaming server 215 can facilitate the compensation of players 106 with a remuneration. According to various embodiments, at the end of a season of competition, the gaming server 215 can determine a final set of standings for the teams involved and distribute prize money according to the final standings. The gaming server 215 can percentage of winnings allotted to each player 106 on a given team.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

Clause 1. A system, comprising: a data store; and at least one computing device in communication with the data store, wherein the at least one computing device is configured to: receive a plurality of character graphics sets individually corresponding to a respective one of a plurality of first remote computing devices, wherein the each respective character graphics set of the plurality of character graphics sets corresponds to at least one physical property of a respective user of a corresponding one of the plurality of first remote computing devices; generate a digital representation of a sports game comprising a plurality of sports players, wherein the plurality of sports players comprises a plurality of first team players for a first team of a plurality of teams and a plurality of second team players for a second team of the plurality of teams; and cause the digital representation of the sports game to be rendered on the plurality of first remote computing devices using individual ones of the plurality of character graphics sets for a corresponding one of the plurality sports players.

Clause 2. The system of clause 1 or any other clause herein wherein the at least one computing device is further configured to alter a digital representation of a particular sports player of the plurality of sports players based on a preference selection received from a corresponding remote computing device of the plurality of first remote computing devices.

Clause 3. The system of clause 1 or any other clause herein, wherein the at least one computing device is further configured to: determine a plurality of sets of preferences individually corresponding to the plurality sports players; and cause the digital representation to be rendered on each of a plurality of displays individually corresponding to a respective one of the plurality of first remote computing devices based on a corresponding set of the plurality of sets of preferences.

Clause 4. The system of clause 3 or any other clause herein, wherein the at least one computing device is further configured to: cause a first digital representation to be rendered by a first computing device of the plurality of first remote computing devices using a first view based on a first set of preferences of the plurality of sets of preferences; and cause a second digital representation to be rendered by a second computing device of the plurality of first remote computing devices using a second view based on a second set of preferences of the plurality of sets of preferences.

Clause 5. The system of clause 1 or any other clause herein, wherein the at least one computing device is further configured to: receive a plurality of input commands from the plurality of first remote computing devices; and adjust at least one respective action of each of the plurality of sports players in the sports game based on the plurality of input commands.

Clause 6. The system of clause 1 or any other clause herein, wherein each respective character graphics set comprises a 3d model of the at least one physical property of the respective user, and the at least one physical property comprises a face of the respective user.

Clause 7. The system of clause 1 or any other clause herein, wherein the at least one computing device is further configured to: receive a selection of a plurality of team properties from an owner account, wherein the plurality of team properties comprise at least one of: a team logo, a team color, and a jersey design; and cause the digital representation of the sports game to be rendered based on the plurality of team properties selected.

Clause 8. A method, comprising: receiving, via one of one or more computing devices, a plurality of character graphics sets individually corresponding to a respective one of a plurality of first remote computing devices, wherein the each respective character graphics set of the plurality of character graphics sets corresponds to at least one physical property of a respective user of a corresponding one of the plurality of first remote computing devices; generating, via one of the one or more computing devices, a digital representation of a sports game comprising a plurality of sports players, wherein the plurality of sports players comprises a plurality of first team players for a first team of a plurality of teams and a plurality of second team players for a second team of the plurality of teams; and causing, via one of the one or more computing devices, the digital representation of the sports game to be rendered on the plurality of first remote computing devices using individual ones of the plurality of character graphics sets for a corresponding one of the plurality sports players.

Clause 9. The method of clause 8 or any other clause herein, further comprising: receiving, via one of the one or more computing devices, a plurality of input commands from the plurality of first remote computing devices; and adjusting, via one of the one or more computing devices, at least one respective action of each of the plurality of sports players in the sports game based on the plurality of input commands.

Clause 10. The method of clause 8 or any other clause herein, wherein the at least one computing device is further configured to: determine a plurality of sets of preferences individually corresponding to the plurality sports players; and cause the digital representation to be rendered on each of a plurality of displays individually corresponding to a respective one of the plurality of first remote computing devices based on a corresponding set of the plurality of sets of preferences.

Clause 11. The method of clause 10 or any other clause herein, further comprising: causing a first digital representation to be rendered by a first computing device of the plurality of first remote computing devices using a first view based on a first set of preferences of the plurality of sets of preferences; and causing a second digital representation to be rendered by a second computing device of the plurality of first remote computing devices using a second view based on a second set of preferences of the plurality of sets of preferences.

Clause 12. The method of clause 8 or any other clause herein, wherein each respective character graphics set comprises a 3d model of the at least one physical property of the respective user, and the at least one physical property comprises a face of the respective user.

Clause 13. The method of clause 8 or any other clause herein, further comprising: receiving a selection of a plurality of team properties from an owner account, wherein the plurality of team properties comprise at least one of: a team logo, a team color, and a jersey design; and causing the digital representation of the sports game to be rendered based on the plurality of team properties selected.

Clause 14. A non-transitory computer-readable medium embodying a program that, when executed by at least one computing device, causes the at least one computing device to: receive a plurality of character graphics sets individually corresponding to a respective one of a plurality of first remote computing devices, wherein the each respective character graphics set of the plurality of character graphics sets corresponds to at least one physical property of a respective user of a corresponding one of the plurality of first remote computing devices; generate a digital representation of a sports game comprising a plurality of sports players, wherein the plurality of sports players comprises a plurality of first team players for a first team of a plurality of teams and a plurality of second team players for a second team of the plurality of teams; and cause the digital representation of the sports game to be rendered on the plurality of first remote computing devices using individual ones of the plurality of character graphics sets for a corresponding one of the plurality sports players.

Clause 15. The non-transitory computer-readable medium of clause 14 or any other clause herein, wherein the program further causes the at least one computing device to: determine a plurality of sets of preferences individually corresponding to the plurality sports players; and cause the digital representation to be rendered on each of a plurality of displays individually corresponding to a respective one of the plurality of first remote computing devices based on a corresponding set of the plurality of sets of preferences.

Clause 16. The non-transitory computer-readable medium of clause 15 or any other clause herein, wherein the program further causes the at least one computing device to: cause a first digital representation to be rendered by a first computing device of the plurality of first remote computing devices using a first view based on a first set of preferences of the plurality of sets of preferences; and cause a second digital representation to be rendered by a second computing device of the plurality of first remote computing devices using a second view based on a second set of preferences of the plurality of sets of preferences.

Clause 17. The non-transitory computer-readable medium of clause 14 or any other clause herein, wherein the program further causes the at least one computing device to: receive a plurality of input commands from the plurality of first remote computing devices; and adjust at least one respective action of each of the plurality of sports players in the sports game based on the plurality of input commands.

Clause 18. The non-transitory computer-readable medium of clause 14 or any other clause herein, wherein each respective character graphics set comprises a 3d model of the at least one physical property of the respective user, and the at least one physical property comprises a face of the respective user.

Clause 19. The non-transitory computer-readable medium of clause 14 or any other clause herein, wherein the program further causes the at least one computing device to: receive a selection of a plurality of team properties from an owner account, wherein the plurality of team properties comprise at least one of: a team logo, a team color, and a jersey design; and cause the digital representation of the sports game to be rendered based on the plurality of team properties selected.

Clause 20. The non-transitory computer-readable medium of clause 14 or any other clause herein, wherein the program further causes the at least one computing device to alter a digital representation of a particular sports player of the plurality of sports players based on a preference selection received from a corresponding remote computing device of the plurality of first remote computing devices.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

What is claimed is:

1. A system, comprising:
a data store; and
at least one computing device in communication with the data store, wherein the at least one computing device is configured to:
receive a plurality of character graphics sets individually corresponding to a respective one of a plurality of first remote computing devices, wherein the each respective character graphics set of the plurality of character graphics sets corresponds to at least one physical property of a respective user of a corresponding one of the plurality of first remote computing devices;
generate a digital representation of a sports game comprising a plurality of sports players, wherein the plurality of sports players comprises a plurality of first team players for a first team of a plurality of teams and a plurality of second team players for a second team of the plurality of teams; and
cause the digital representation of the sports game to be rendered on the plurality of first remote computing devices using individual ones of the plurality of character graphics sets for a corresponding one of the plurality sports players.

2. The system of claim 1, wherein the at least one computing device is further configured to alter a digital representation of a particular sports player of the plurality of sports players based on a preference selection received from a corresponding remote computing device of the plurality of first remote computing devices.

3. The system of claim 1, wherein the at least one computing device is further configured to:
determine a plurality of sets of preferences individually corresponding to the plurality sports players; and
cause the digital representation to be rendered on each of a plurality of displays individually corresponding to a respective one of the plurality of first remote computing devices based on a corresponding set of the plurality of sets of preferences.

4. The system of claim 3, wherein the at least one computing device is further configured to:
cause a first digital representation to be rendered by a first computing device of the plurality of first remote computing devices using a first view based on a first set of preferences of the plurality of sets of preferences; and
cause a second digital representation to be rendered by a second computing device of the plurality of first remote computing devices using a second view based on a second set of preferences of the plurality of sets of preferences.

5. The system of claim 1, wherein the at least one computing device is further configured to:
receive a plurality of input commands from the plurality of first remote computing devices; and
adjust at least one respective action of each of the plurality of sports players in the sports game based on the plurality of input commands.

6. The system of claim 1, wherein each respective character graphics set comprises a 3d model of the at least one physical property of the respective user, and the at least one physical property comprises a face of the respective user.

7. The system of claim 1, wherein the at least one computing device is further configured to:
receive a selection of a plurality of team properties from an owner account, wherein the plurality of team properties comprise at least one of: a team logo, a team color, and a jersey design; and
cause the digital representation of the sports game to be rendered based on the plurality of team properties selected.

8. A method, comprising:
receiving, via one of one or more computing devices, a plurality of character graphics sets individually corresponding to a respective one of a plurality of first remote computing devices, wherein the each respective character graphics set of the plurality of character graphics sets corresponds to at least one physical property of a respective user of a corresponding one of the plurality of first remote computing devices;
generating, via one of the one or more computing devices, a digital representation of a sports game comprising a plurality of sports players, wherein the plurality of sports players comprises a plurality of first team players for a first team of a plurality of teams and a plurality of second team players for a second team of the plurality of teams; and
causing, via one of the one or more computing devices, the digital representation of the sports game to be rendered on the plurality of first remote computing devices using individual ones of the plurality of character graphics sets for a corresponding one of the plurality sports players.

9. The method of claim 8, further comprising:
receiving, via one of the one or more computing devices, a plurality of input commands from the plurality of first remote computing devices; and
adjusting, via one of the one or more computing devices, at least one respective action of each of the plurality of sports players in the sports game based on the plurality of input commands.

10. The method of claim 8, wherein the at least one computing device is further configured to:
determining a plurality of sets of preferences individually corresponding to the plurality sports players; and
causing the digital representation to be rendered on each of a plurality of displays individually corresponding to a respective one of the plurality of first remote computing devices based on a corresponding set of the plurality of sets of preferences.

11. The method of claim 10, further comprising:
causing a first digital representation to be rendered by a first computing device of the plurality of first remote computing devices using a first view based on a first set of preferences of the plurality of sets of preferences; and
causing a second digital representation to be rendered by a second computing device of the plurality of first remote computing devices using a second view based on a second set of preferences of the plurality of sets of preferences.

12. The method of claim 8, wherein each respective character graphics set comprises a 3d model of the at least one physical property of the respective user, and the at least one physical property comprises a face of the respective user.

13. The method of claim 8, further comprising:
receiving a selection of a plurality of team properties from an owner account, wherein the plurality of team properties comprise at least one of: a team logo, a team color, and a jersey design; and
causing the digital representation of the sports game to be rendered based on the plurality of team properties selected.

14. A non-transitory computer-readable medium embodying a program that, when executed by at least one computing device, causes the at least one computing device to:
receive a plurality of character graphics sets individually corresponding to a respective one of a plurality of first remote computing devices, wherein the each respective character graphics set of the plurality of character graphics sets corresponds to at least one physical property of a respective user of a corresponding one of the plurality of first remote computing devices;
generate a digital representation of a sports game comprising a plurality of sports players, wherein the plurality of sports players comprises a plurality of first team players for a first team of a plurality of teams and a plurality of second team players for a second team of the plurality of teams; and
cause the digital representation of the sports game to be rendered on the plurality of first remote computing devices using individual ones of the plurality of character graphics sets for a corresponding one of the plurality sports players.

15. The non-transitory computer-readable medium of claim 14, wherein the program further causes the at least one computing device to:
determine a plurality of sets of preferences individually corresponding to the plurality sports players; and
cause the digital representation to be rendered on each of a plurality of displays individually corresponding to a respective one of the plurality of first remote computing devices based on a corresponding set of the plurality of sets of preferences.

16. The non-transitory computer-readable medium of claim 15, wherein the program further causes the at least one computing device to:
cause a first digital representation to be rendered by a first computing device of the plurality of first remote computing devices using a first view based on a first set of preferences of the plurality of sets of preferences; and
cause a second digital representation to be rendered by a second computing device of the plurality of first remote computing devices using a second view based on a second set of preferences of the plurality of sets of preferences.

17. The non-transitory computer-readable medium of claim 14, wherein the program further causes the at least one computing device to:
receive a plurality of input commands from the plurality of first remote computing devices; and
adjust at least one respective action of each of the plurality of sports players in the sports game based on the plurality of input commands.

18. The non-transitory computer-readable medium of claim 14, wherein each respective character graphics set comprises a 3d model of the at least one physical property of the respective user, and the at least one physical property comprises a face of the respective user.

19. The non-transitory computer-readable medium of claim 14, wherein the program further causes the at least one computing device to:
receive a selection of a plurality of team properties from an owner account, wherein the plurality of team properties comprise at least one of: a team logo, a team color, and a jersey design; and
cause the digital representation of the sports game to be rendered based on the plurality of team properties selected.

20. The non-transitory computer-readable medium of claim 14, wherein the program further causes the at least one computing device to alter a digital representation of a particular sports player of the plurality of sports players based on a preference selection received from a corresponding remote computing device of the plurality of first remote computing devices.
